(19) United States
(12) Patent Application Publication
(10) Pub. No.: US 2023/0313582 A1
(43) Pub. Date: Oct. 5, 2023

(54) VEHICLE DOOR DEVICE

(71) Applicant: AISIN CORPORATION, Kariya (JP)

(72) Inventors: Jueru SHIMIZU, Kariya-shi (JP); Sho KUME, Kariya-shi (JP)

(73) Assignee: AISIN CORPORATION, Kariya (JP)

(21) Appl. No.: 18/159,144

(22) Filed: Jan. 25, 2023

(30) Foreign Application Priority Data
Mar. 30, 2022 (JP) 2022-056056

(51) Int. Cl. E05D 15/28; B60J 5/04; E05F 15/63

(52) U.S. Cl. CPC E05D 15/28; B60J 5/047; E05F 15/63; E05Y 2201/624; E05Y 2201/434; E05Y 2201/686; E05Y 2900/531

(57) ABSTRACT

A vehicle door device includes first and second link arms each of which has a first rotation connection point with respect to a vehicle body and a second rotation connection point with respect to a door of a vehicle, and a drive device that opens and closes the door based on an operation of a link mechanism formed by the first and second link arms by rotating at least one of the first and second link arms as a drive link, wherein the drive device rotates the drive link by applying a driving torque to the second rotation connection point.

### CROSS REFERENCE TO RELATED APPLICATIONS

This application is based on and claims priority under 35 U.S.C. § 119 to Japanese Patent Application No. 2022-056056, filed on Mar. 30, 2022, the entire content of which is incorporated herein by reference.

### TECHNICAL FIELD

The present disclosure relates to a vehicle door device.

### BACKGROUND DISCUSSION

In the related art, provided is a vehicle door device including first and second link arms each of which has a first rotation connection point with respect to a vehicle body and a second rotation connection point with respect to a door of a vehicle. In such a vehicle door device, the door provided in the door opening is opened and closed based on the operation of the link mechanism formed by the first and second link arms. For example, JP 2006-90097 A describes a configuration in which these link arms are stored at positions outside a door opening attached to a terminal portion of a side portion of a vehicle body and inside a weather strip attached to a vehicle interior side of the door.

In addition, in vehicles, many in-vehicle devices are being powered and electrically powered. An optimal design of the drive device including the arrangement of the door device using the link mechanism as described above is also being looked for.

A need this exists for a vehicle door device which is not susceptible to the drawback mentioned above.

### SUMMARY

A vehicle door device includes first and second link arms each of which has a first rotation connection point with respect to a vehicle body and a second rotation connection point with respect to a door of a vehicle, and a drive device that opens and closes the door based on an operation of a link mechanism formed by the first and second link arms by rotating at least one of the first and second link arms as a drive link, wherein the drive device rotates the drive link by applying a driving torque to the second rotation connection point.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a door device;

FIG. 2 is a perspective view of the door device;

FIG. 3 is a plan view of first and second link arms forming the link mechanism;

FIG. 4 is a plan view of first and second link arms forming the link mechanism;

FIG. 5 is a plan view of first and second link arms forming the link mechanism;

FIG. 6 is a plan view of first and second link arms forming the link mechanism;

FIG. 7 is a schematic configuration diagram of a door engagement portion and a vehicle body engagement portion;

FIG. 8 is an explanatory view illustrating arrangement of a door engagement portion and a vehicle body engagement portion;

FIG. 9 is a perspective view of a door and a door opening illustrating arrangement of a door engagement portion and a vehicle body engagement portion;

FIG. 10 is a plan view of the joint link mechanism constituting the connection length variable mechanism; and

FIG. 11 is a plan view of the joint link mechanism constituting the connection length variable mechanism.

### DETAILED DESCRIPTION

Hereinafter, an embodiment of a vehicle door device will be described with reference to the drawings.

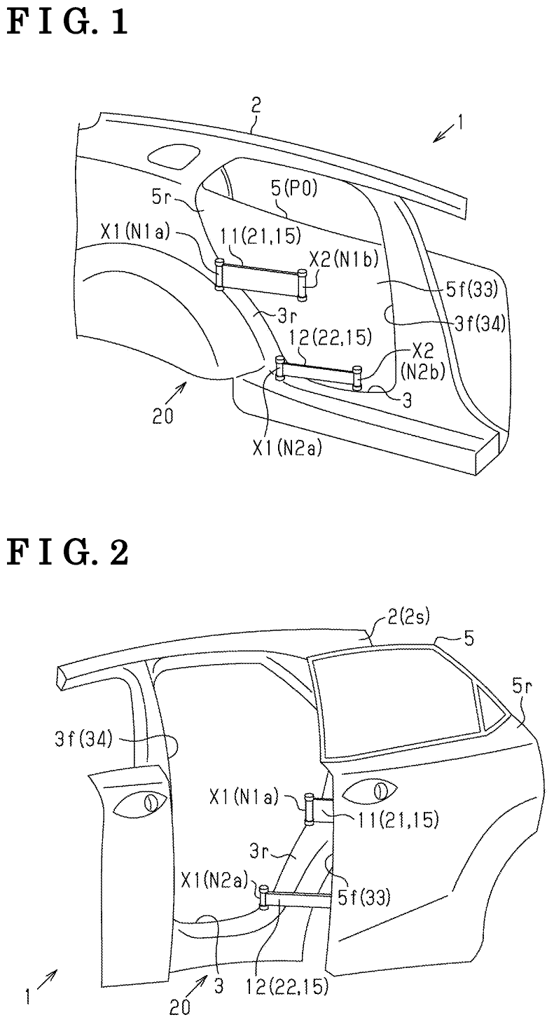

As illustrated in FIGS. 1 and 2, a vehicle 1 of the present embodiment includes a door opening 3 provided on a side face 2s of a vehicle body 2. The door opening 3 is provided with a first link arm 11 and a second link arm 12 that support a door 5 of the vehicle 1 at the door opening 3.

More specifically, in the vehicle 1 of the present embodiment, each of the first and second link arms 11 and 12 has a first rotation connection point X1 with respect to the vehicle body 2 and a second rotation connection point X2 with respect to the door 5. Specifically, the first link arm 11 is connected to the vehicle body 2 in a state of being pivotally supported by a support shaft N1a extending in the vertical direction (in each drawing, vertical direction), and is connected to the door 5 in a state of being pivotally supported by a support shaft N1b extending in the vertical direction. The second link arm 12 is connected to the vehicle body 2 in a state of being pivotally supported by a support shaft N2a extending in the vertical direction, and connected to the door 5 in a state of being pivotally supported by a support shaft N2b extending in the vertical direction.

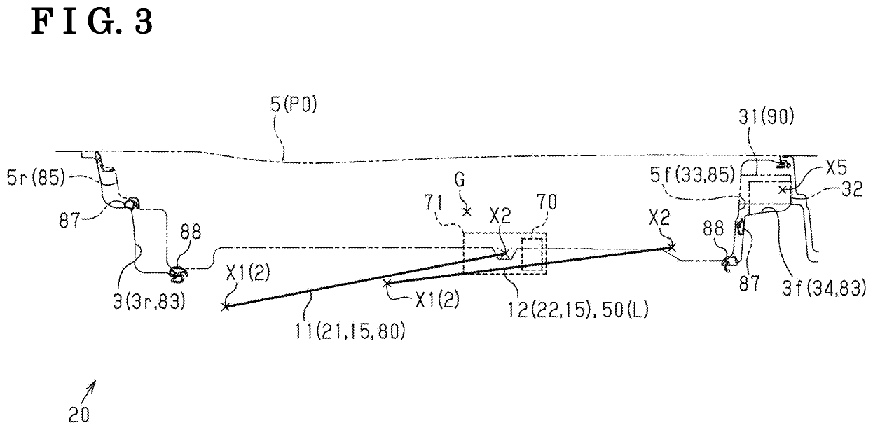

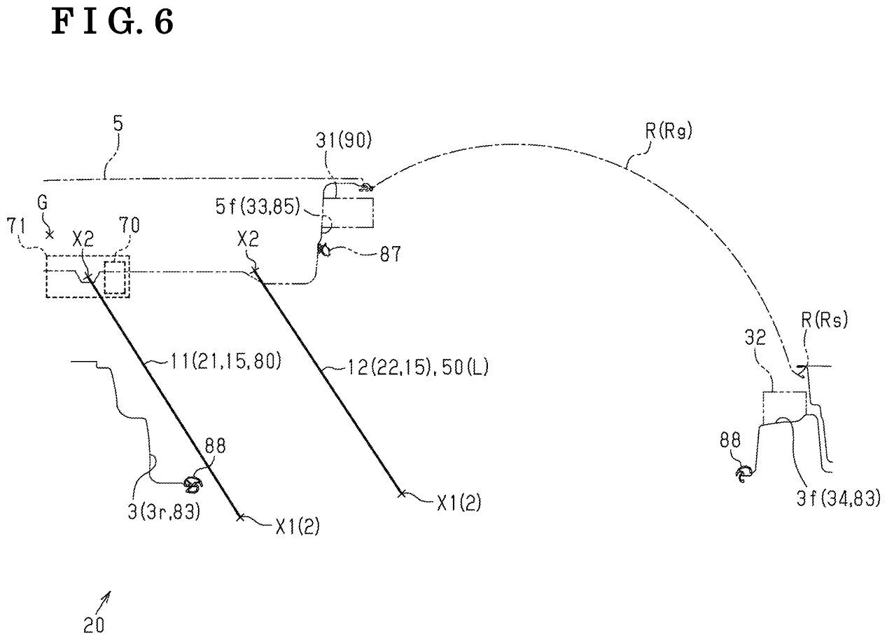

That is, as illustrated in FIGS. 3 to 6, in the vehicle 1 of the present embodiment, the first and second link arms 11 and 12 form a link mechanism 15 having a configuration as a four-bar link. The vehicle 1 of the present embodiment is configured such that the door 5 supported by the door opening 3 is opened and closed based on the operation of the link mechanism 15.

More specifically, as illustrated in FIGS. 1 and 2, the vehicle 1 of the present embodiment uses the first and second link arms 11 and 12 to support the door 5 in the door opening 3 on the vehicle rear side (Left side in FIG. 1, right side in FIG. 2). In the vehicle 1 of the present embodiment, each of the first and second link arms 11 and 12 has the first rotation connection point X1 rotatably connected to the vehicle body 2 in the vicinity of a rear edge 3r of the door opening 3. In the vehicle 1 of the present embodiment, the first and second link arms 11 and 12 are disposed away from each other in the vertical direction.

In the vehicle 1 of the present embodiment, the first link arm 11 is provided above the second link arm 12. The first link arm 11 has the second rotation connection point X2 rotatably connected to the door 5 at a substantially central position in the front-rear direction of the door 5. On the other hand, the second link arm 12 has the second rotation connection point X2 connected to the door 5 in the vicinity of a front end portion 5f of the door 5. Then, in the vehicle 1 of the present embodiment, a door device 20 in which the door 5 is opened and closed based on the operation of the link mechanism 15 formed by the first and second link arms 11 and 12 is formed.

Specifically, as illustrated in FIGS. 3 to 6, in the door device 20 of the present embodiment, when the door 5 is opened, the first and second link arms 11 and 12 rotate in the counterclockwise direction in each drawing around the first rotation connection point X1. As a result, the door 5 of the vehicle 1 supported by the first and second link arms 11 and 12 performs an opening operation toward the vehicle rear direction (left side in each drawing).

In addition, in the door device 20 of the present embodiment, when the door 5 is closed, the first and second link arms 11 and 12 rotate in the clockwise direction in each drawing around the first rotation connection point X1. Thus, the door 5 of the vehicle 1 supported by the first and second link arms 11 and 12 is configured to perform a closing operation toward the vehicle front direction (right side in each drawing).

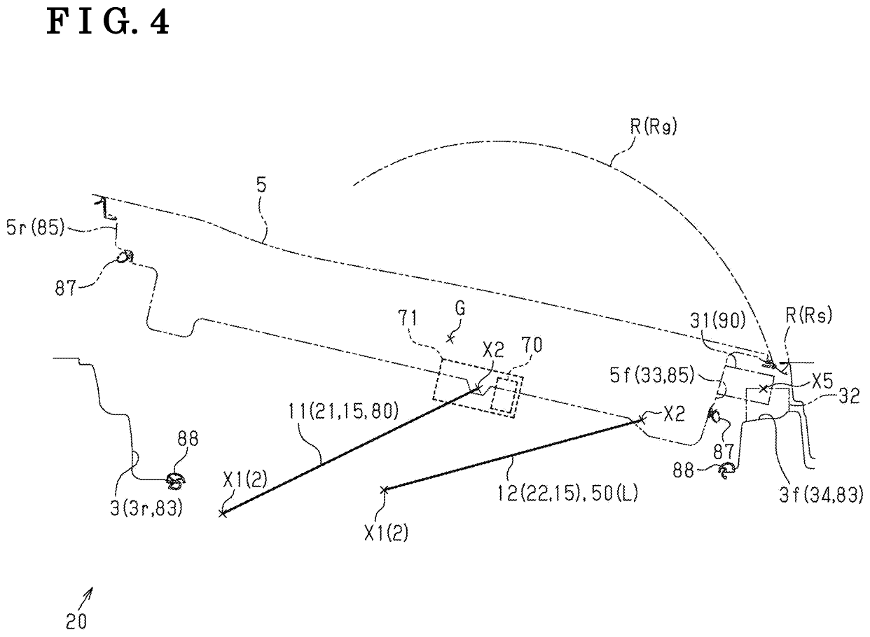

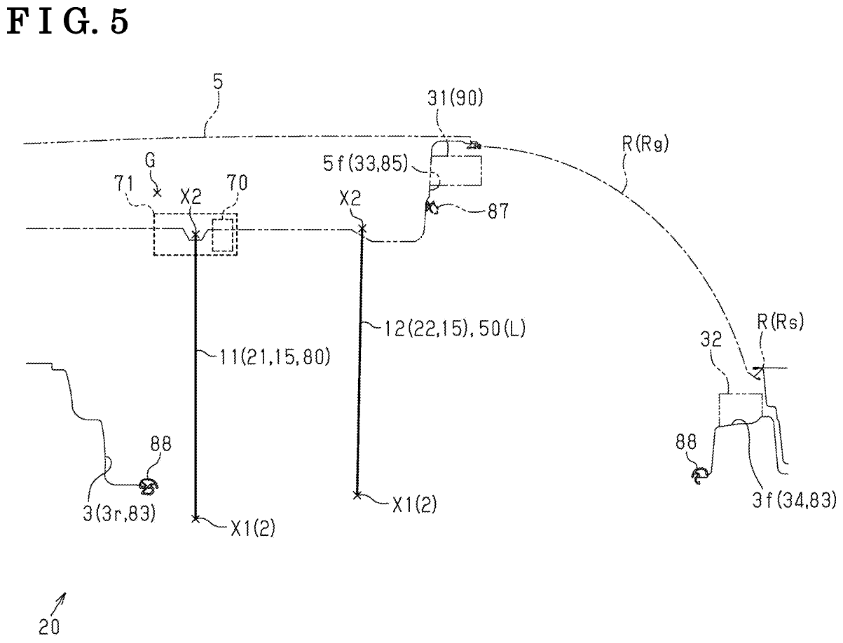

Furthermore, in the door device 20 of the present embodiment, an opening and closing operation locus R of the door 5 is defined so as to draw an arc-shaped locus Rg based on the operation of the link mechanism 15 formed by the first and second link arms 11 and 12. That is, as illustrated in FIG. 5, at the intermediate position where the first and second link arms 11 and 12 extend in the vehicle width direction (in FIGS. 3 to 6, vertical direction), the movement component in the vehicle front-rear direction increases. As illustrated in FIGS. 3 and 4, the closer the opening and closing operation position of the door 5 is to a fully closed position P0, the more the first and second link arms 11 and 12 extend in the vehicle front-rear direction (left-right direction in FIGS. 3 to 6), so that the movement component in the vehicle width direction increases.

Further, in the door device 20 of the present embodiment, the first link arm 11 has the second rotation connection point X2 with respect to the door 5 at a position closer to the center of gravity G than the second link arm 12. That is, in the door device 20 of the present embodiment, the first link arm 11 is thus served as a main link 21 that supports a larger door load. The second link arm 12 is served as a sub-link 22 in which the acting door load is relatively small.

In the door device 20 of the present embodiment, the first link arm 11 has a larger outer shape than the second link arm 12. Thus, the door device 20 of the present embodiment is configured to impart high support rigidity to the first link arm 11 served as the main link 21.

As illustrated in FIGS. 3 to 7, the door device 20 of the present embodiment includes a door engagement portion 31 provided at the front end portion 5f of the door 5 and a vehicle body engagement portion 32 provided at a front edge 3f of the door opening 3. That is, in the vehicle 1 of the present embodiment, the door engagement portion 31 is provided at a close side end 33 located on the closing operation side of the door 5 that opens and closes the door opening 3 of the vehicle 1 based on the operation of the link mechanism 15 formed by the first and second link arms 11 and 12. Further, the vehicle body engagement portion 32 is provided at a close side end 34 of the door opening 3 which the close side end 33 of the door 5 comes into contact with and is away from, that is, approaches or is away from, based on the opening and closing operation of the door 5 moving in the vehicle front-rear direction. The door device 20 of the present embodiment is configured such that the door engagement portion 31 and the vehicle body engagement portion 32 are engaged with each other in a state where the door 5 is in the vicinity of the fully closed position P0.

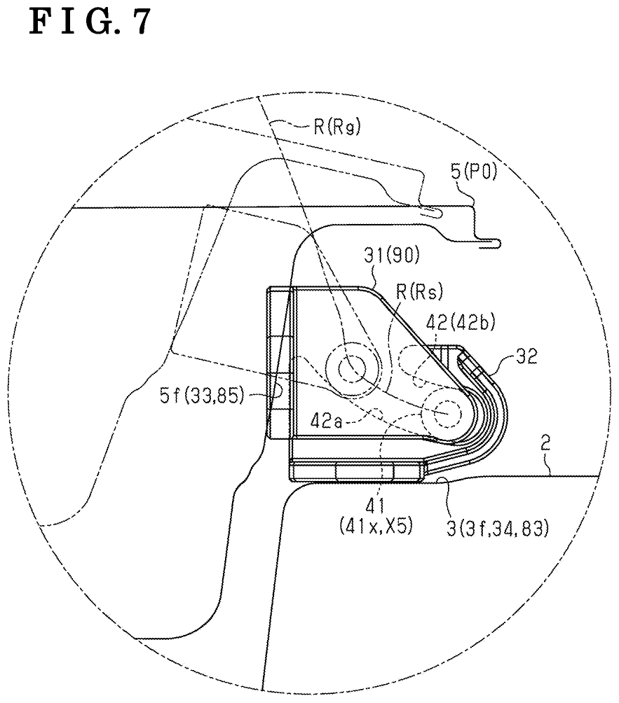

More specifically, the door engagement portion 31 of the present embodiment includes a shaft-shaped engagement portion 41 extending in the vertical direction (in FIG. 7, a direction orthogonal to the paper surface) of the vehicle 1 as the guide engagement portion. In the door device 20 of the present embodiment, the shaft-shaped engagement portion 41 as the guide engagement portion has a configuration as a roller 41x rotatably supported around a support shaft (not illustrated) extending in the vertical direction. Further, the vehicle body engagement portion 32 includes a guide groove 42 having a pair of side wall portions 42a and 42b facing each other in the vehicle width direction (in FIG. 7, the vertical direction) and extending in the opening and closing operation direction of the door 5. When the door 5 is in the vicinity of the fully closed position P0, the door device 20 of the present embodiment is configured such that the door engagement portion 31 and the vehicle body engagement portion 32 are engaged with each other in a state where the shaft-shaped engagement portion 41 constituting the guide engagement portion is disposed in the guide groove 42.

That is, the shaft-shaped engagement portion 41 of the door engagement portion 31 is disposed in the guide groove 42 of the vehicle body engagement portion 32 in a state of being sandwiched between the pair of side wall portions 42a and 42b facing each other in the vehicle width direction, whereby the displacement of the door 5 in the vehicle width direction is restricted. Thus, the door device 20 of the present embodiment can stably support the door 5 even in the vicinity of the fully closed position P0 where the first and second link arms 11 and 12 forming the link mechanism 15 are likely to be linearly disposed.

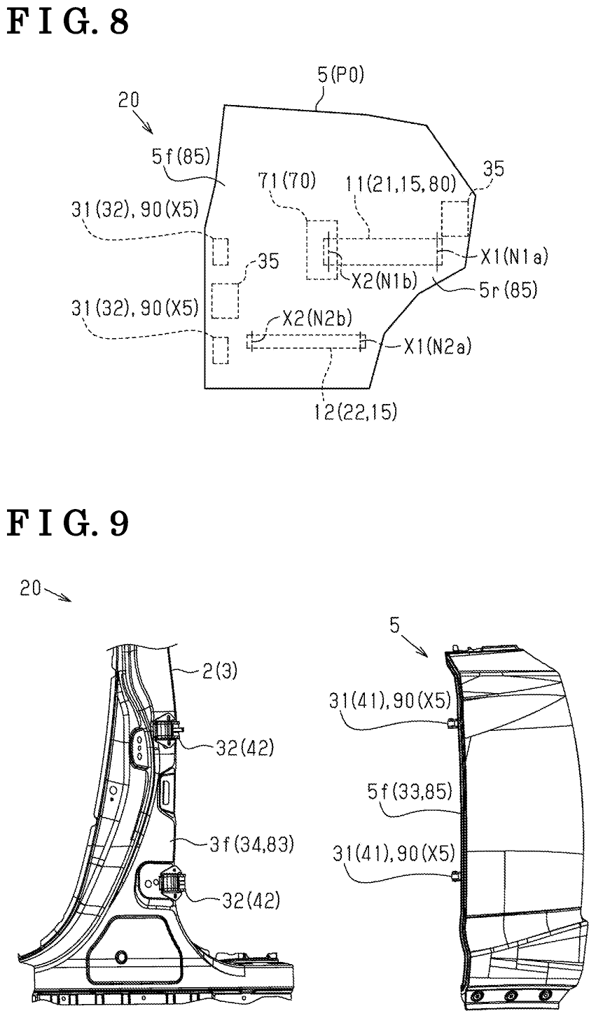

As illustrated in FIGS. 8 and 9, the door device 20 of the present embodiment includes the door engagement portions 31 and 31 provided at the front end portion 5f of the door 5 at two positions away from each other in the vertical direction. Further, the door device 20 includes the vehicle body engagement portions 32 and 32 provided at the front edge 3f of the door opening 3 at two positions away from each other in the vertical direction. The door device 20 of the present embodiment is configured to hold the door 5 at the fully closed position P0 in a state where the door engagement portions 31 and 31 and the vehicle body engagement portions 32 and 32 are engaged with each other.

In addition, the door device 20 of the present embodiment includes lock devices 35 and 35 provided at the front end portion 5f and the rear end portion 5r of the door 5. The door device 20 of the present embodiment is configured such that the latch mechanism (not illustrated) constituting each lock device 35 is engaged with a striker (not illustrated) provided in the vehicle body 2, whereby the door 5 is restrained at the fully closed position P0.

As illustrated in FIGS. 3 to 6, in the door device 20 of the present embodiment, the second link arm 12 served as the sub-link 22 is provided with a connection length variable mechanism 50 that is allowed to change a connection length L between the first and second rotation connection points X1 and X2. Further, the connection length variable mechanism 50 is biased in a direction of shortening the length between the first and second rotation connection points X1 and X2, that is, the connection length L of the door 5 by the second link arm 12 provided with the connection length variable mechanism 50. Then, the door device 20 of the present embodiment is configured such that the door 5 is opened and closed in a state where the connection length L by the second link arm 12 is shortened.

As illustrated in FIGS. 3, 4, and 7, in the door device 20 of the present embodiment, the opening and closing operation of the door 5 in a state where the door engagement portion 31 and the vehicle body engagement portion 32 are engaged with each other is allowed based on the operation of the connection length variable mechanism 50 provided in the second link arm 12. Specifically, when the door 5 is opened and closed in a state where the door engagement portion 31 and the vehicle body engagement portion 32 are engaged with each other, the shaft-shaped engagement portion 41 is relatively displaced along the extending direction of the guide groove 42 along with the change in the connection length L based on the operation of the connection length variable mechanism 50. Then, in the door device 20 of the present embodiment, the opening and closing operation locus R of the door 5 changes accordingly.

That is, in the door device 20 of the present embodiment, when the door 5 moves to the fully closed position P0, the door engagement portion 31 is engaged with the vehicle body engagement portion 32, so that the opening and closing operation of the door 5 is guided in a state where the shaft-shaped engagement portion 41 is disposed in the guide groove 42. The door device 20 according to the present embodiment is thus configured such that the arc-shaped locus Rg based on the operation of the link mechanism 15 changes to a linear locus Rs along the opening width direction of the door opening 3.

Specifically, in the door device 20 of the present embodiment, when the door 5 is fully closed, the operating force in the closing operation direction is applied to the door 5 in a state where the door engagement portion 31 and the vehicle body engagement portion 32 are engaged with each other. In the door device 20 of the present embodiment, the driving force of the drive device described later or the manual operation of the user is assumed as the operating force for opening and closing the door 5. Furthermore, in this case, the connection length variable mechanism 50 provided in the second link arm 12 operates based on the operating force in the closing operation direction, whereby the connection length L of the door 5 by the second link arm 12 is extended based on the engagement state between the door engagement portion 31 and the vehicle body engagement portion 32.

Thus, the door device 20 of the present embodiment is configured such that the door 5 supported by the link mechanism 15 performs the closing operation toward the fully closed position P0 in the mode of drawing the linear locus Rs as described above.

When the door 5 performs the opening operation from the fully closed position P0, the operating force in the opening operation direction is applied to the door 5 in a state where the door engagement portion 31 and the vehicle body engagement portion 32 are engaged with each other.

Furthermore, in this case, the connection length variable mechanism 50 operates based on the operating force in the opening operation direction, whereby the connection length L of the door 5 by the second link arm 12 is shortened based on the engagement state between the door engagement portion 31 and the vehicle body engagement portion 32. Thus, the door device 20 of the present embodiment is configured such that the door 5 supported by the link mechanism 15 performs the opening operation from the fully closed position P0 in the mode of drawing the linear locus Rs.

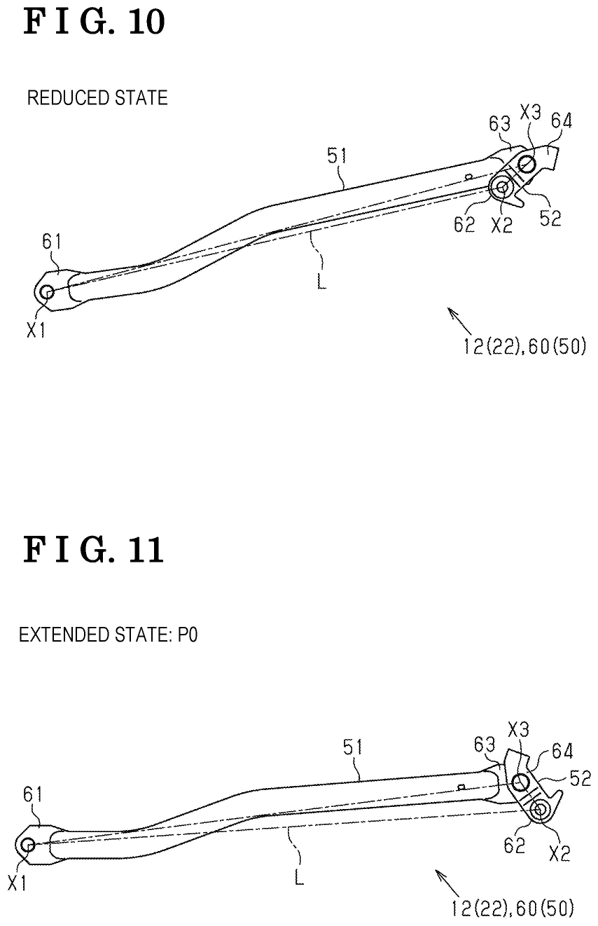

More specifically, as illustrated in FIGS. 10 and 11, in the door device 20 of the present embodiment, the second link arm 12 includes a vehicle body link 51 and a door link 52. That is, the vehicle body link 51 has the first rotation connection point X1 with respect to the vehicle body 2. The door link 52 has the second rotation connection point X2 with respect to the door 5 of the vehicle 1. Furthermore, in the door device 20 of the present embodiment, the second link arm 12 has a configuration in which the vehicle body link 51 and the door link 52 are rotatably connected. Further, the door device 20 of the present embodiment is configured such that a joint link mechanism 60 formed by this function as the connection length variable mechanism 50.

Specifically, the door link 52 of the present embodiment has a configuration as a so-called mini arm having a short axial length in comparison with the vehicle body link 51. Further, the vehicle body link 51 has a vehicle body connection portion 61 with respect to the vehicle body 2 at one end in the longitudinal direction. Further, the door link 52 also has a door connection portion 62 with respect to the door 5 at one end in the longitudinal direction. The vehicle body link 51 and the door link 52 have intermediate connection portions 63 and 64 connected to each other at the other end in the longitudinal direction.

That is, in the door device 20 of the present embodiment, the intermediate connection portions 63 and 64 form an intermediate connection point X3 of the joint link mechanism 60 provided in the second link arm 12.

In the second link arm 12, the vehicle body link 51 and the door link 52 form a triangle with the intermediate connection point X3 as a vertex. As a result, the vehicle body link 51 and the door link 52 relatively rotate, so that the length of the straight line connecting the first and second rotation connection points X1 and X2, which are the bases of the triangle, that is, the connection length L thereof changes.

(Drive Device)

Next, a drive device provided in the door device 20 of the present embodiment will be described.

As illustrated in FIGS. 3 to 6 and 8, the door device 20 of the present embodiment includes a drive device 71 that drives to open and close the door 5, of the vehicle 1, supported by the link mechanism 15 formed by the first and second link arms 11 and 12 with a motor 70 as a drive source.

In the door device 20 of the present embodiment, the drive device 71 is provided in the door 5.

Furthermore, the drive device 71 applies a driving torque to the second rotation connection point X2 of the first link arm 11 served as the main link 21 with respect to the door 5. That is, the drive device 71 rotates the first link arm 11 set in a drive link 80 around the second rotation connection point X2 with respect to the door 5 based on the driving torque. Then, the drive device 71 of the present embodiment is configured to open and close the door 5 of the vehicle 1 based on the operation of the link mechanism 15 formed by the first link arm 11 and the second link arm 12.

(Action)

Next, an action of the present embodiment will be described.

As illustrated in FIGS. 3 and 4, normally, the door 5 that opens and closes the door opening 3 of the vehicle 1 moves to a fully closed position P0 while crushing a peripheral edge portion 83 of the door opening 3 and weather strips 87 and 88 provided as seal members on a peripheral edge portion 85 of the door 5. For this reason, when the door 5 is fully closed, a driving force larger than that at the time of the opening and closing operation when the door 5 is in another situation is required.

Here, as described above, when the door 5 moves to the fully closed position P0 while crushing the weather strips 87 and 88, the “point of action” of the force for driving the door 5 to the fully closed position P0 is the peripheral edge portion 85, of the door 5, crushing the weather strips 87 and 88. When a position to which the force for opening and closing the door 5 is applied is referred to as a “point of force”, the “point of force” is a position at which the drive device 71 applies the driving torque to the drive link 80.

Based on this point, in the door device 20 of the present embodiment, the driving torque of the drive device 71 is applied to the second rotation connection point X2 with respect to the door 5. That is, the “point of force” of the force for driving the door 5 in the closing operation direction is closer to the “point of action” when the driving torque is applied to the second rotation connection point X2 with respect to the door 5 than when the driving torque is applied to the first rotation connection point X1 with respect to the vehicle body 2. Thus, the door device 20 of the present embodiment can efficiently fully close the door 5 supported by the door opening 3 via the first and second link arms 11 and 12.

Further, in the door device 20 of the present embodiment, when the door 5 is fully closed, the door engagement portion 31 provided at the close side end 33 of the door 5 and the vehicle body engagement portion 32 provided at the close side end 34 of the door opening 3 are engaged with each other. Further, in the vicinity of the fully closed position P0 where the door engagement portion 31 and the vehicle body engagement portion 32 are engaged with each other, the opening and closing operation of the door 5 is guided in a state where a shaft-shaped engagement portion 41 as a guide engagement portion is disposed in the guide groove 42. Specifically, when the door engagement portion 31 is engaged with the vehicle body engagement portion 32, the door 5 is in an inclined posture in which a rear end portion 5r thereof protrudes outward in the vehicle width direction (upper side in the figure) relative to a front end portion 5f. Then, in the door device 20 of the present embodiment, the door 5 is fully closed while the rear end portion 5r moves inside in the vehicle width direction (lower side in the figure).

In other words, in the door device 20 according to the present embodiment, the door engagement portion 31 provided at the front end portion 5f of the door 5 is engaged with the vehicle body engagement portion 32 provided at the front edge 3f of the door opening 3 when the door is fully closed, whereby a rotation fulcrum X5 of the door 5 is formed. Then, the door 5 of the present embodiment turns around the rotation fulcrum X5 to move to the fully closed position P0 while crushing the peripheral edge portion 83 of the door opening 3 and the weather strips 87 and 88 provided on the peripheral edge portion 85 of the door 5.

That is, in the door device 20 of the present embodiment, the door engagement portion 31 engaged with the vehicle body engagement portion 32, more specifically, the shaft-shaped engagement portion 41 disposed in the guide groove 42 is a fulcrum forming portion 90 that forms the rotation fulcrum X5 of the door 5 at the peripheral edge portion 83 of the door opening 3 when the door is fully closed.

When the first and second link arms 11 and 12 are compared, the distance between the fulcrum forming portion 90 and the second rotation connection point X2 with respect to the door 5 is larger in the first link arm 11 than in the second link arm 12.

Based on this point, in the door device 20 of the present embodiment, the driving torque of the drive device 71 is applied to the second rotation connection point X2 with respect to the door 5 with the first link arm 11 as the drive link 80. That is, according to the “principle of leverage”, a larger driving force can be applied to the door 5 when the “point of force” of the force for driving the door 5 in the closing operation direction is away from the rotation fulcrum X5 formed by the fulcrum forming portion 90, that is, at a more distant position. Thus, the door device 20 of the present embodiment can more efficiently fully close the door 5 supported by the door opening 3 via the first and second link arms 11 and 12.

Next, effects of the present embodiment will be described.

(1) The vehicle door device 20 includes the first and second link arms 11 and 12 each having the first rotation connection point X1 with respect to the vehicle body 2 and the second rotation connection point X2 with respect to the door 5 of the vehicle 1. In addition, the door device 20 includes the drive device 71 that rotates the drive link 80 with the first link arm 11 as the drive link 80 to open and close the door 5 based on the operation of the link mechanism 15 formed by the first and second link arms 11 and 12. Then, the drive device 71 rotates the first link arm 11 as the drive link 80 by applying a driving torque to the second rotation connection point X2 with respect to the door 5.

That is, a vehicle door device includes first and second link arms each of which has a first rotation connection point with respect to a vehicle body and a second rotation connection point with respect to a door of a vehicle; and a drive device that opens and closes the door based on an operation of a link mechanism formed by the first and second link arms by rotating at least one of the first and second link arms as a drive link, wherein the drive device rotates the drive link by applying a driving torque to the second rotation connection point.

According to the above configuration, when a position to which the force for driving the door 5 is applied during the opening and closing operation of the door 5 is referred to as a “point of force”, it is possible to more efficiently open/close the door 5 supported by the first and second link arms 11 and 12 when the “point of force” is closer to the door 5 to be driven.

Specifically, normally, the door 5 that opens and closes the door opening 3 of the vehicle 1 moves to the fully closed position P0 while crushing the peripheral edge portion 83 of the door opening 3 and the weather strips 87 and 88 provided as seal members on the peripheral edge portion 85 of the door 5. For this reason, when the door 5 is fully closed, a driving force larger than that at the time of the opening and closing operation when the door 5 is in another situation is required. At this time, the “point of action” of the force for driving the door 5 to the fully closed position P0 is the peripheral edge portion 85, of the door 5, that crushes the weather strips 87 and 88. Therefore, according to the above configuration, the application position of the driving torque for fully closing the door 5 based on the rotation of the drive link 80, that is, the “point of force” for fully closing the door 5 using the drive device 71 can be set at a position closer to the “point of action”.

Further, in the vicinity of the fully closed position P0, the first and second link arms 11 and 12 forming the link mechanism 15 are linearly disposed close to each other. Therefore, the door 5 supported by the first and second link arms 11 and 12 easily swings. However, according to the above configuration, even in such a situation, the driving force of the opening and closing operation can be efficiently transmitted to the door 5. Furthermore, the downsizing of the drive device 71 can improve mountability. Thus, the door 5 of the vehicle 1 can be suitably opened and closed.

(2) In addition, the door 5 has the fulcrum forming portion 90 that forms the rotation fulcrum X5 of the door 5 at the peripheral edge portion 83 of the door opening 3 where the door 5 is provided when the door is fully closed. When the first and second link arms 11 and 12 are compared, the distance between the fulcrum forming portion 90 and the second rotation connection point X2 with respect to the door 5 is larger in the first link arm 11 than in the second link arm 12.

That is, in the vehicle door device, the door includes a fulcrum forming portion that forms a rotation fulcrum of the door at a peripheral edge portion of a door opening where the door is provided when the door is fully closed, and performs the fully closing operation, and wherein one, of the first and second link arms, having the second rotation connection point at a position farther from the fulcrum forming portion is set as the drive link.

According to the above configuration, according to the “principle of leverage”, a larger driving force can be applied to the door 5 when the “point of force” of the force for driving the door 5 in the closing operation direction is away from the rotation fulcrum X5 formed by the fulcrum forming portion 90, that is, at a more distant position. Therefore, with the first link arm 11 as the drive link 80, the door 5 supported by the door opening 3 via the first and second link arms 11 and 12 can be fully closed more efficiently. Furthermore, the drive device 71 can be further downsized to improve mountability. Thus, the door 5 of the vehicle 1 can be more suitably opened and closed.

(3) The door device 20 includes the connection length variable mechanism 50 which is provided in the second link arm 12 having a configuration as the sub-link 22 and allowed to change a connection length L between the first and second rotation connection points X1 and X2. The door device 20 is configured such that the opening and closing operation locus R of the door 5 changes based on the operation of the connection length variable mechanism 50.

That is, the vehicle door device includes a connection length variable mechanism provided at one of the first and second link arms and allowed to change a connection length between the first and second rotation connection points, wherein an opening and closing operation locus of the door changes based on an operation of the connection length variable mechanism, and wherein the other, of the first and second link arms, not provided with the connection length variable mechanism is set as the drive link.

According to the above configuration, the degree of freedom of the opening and closing operation can be increased based on the operation of the connection length variable mechanism 50 provided in the second link arm 12. In addition, since the first link arm 11 not provided with such a connection length variable mechanism 50 is set as the drive link 80, the door 5 is less likely to swing due to the operation of the connection length variable mechanism 50 at the time of opening/closing drive of the door 5 by the drive device 71. Thus, the door 5 of the vehicle 1 can be more suitably opened and closed.

(4) The door device 20 includes the door engagement portion 31 provided at the close side end 33 of the door 5, and the vehicle body engagement portion 32 provided at the close side end 34 of the door opening 3 which the close side end 33 of the door 5 comes into contact with and is away from based on the opening and closing operation of the door 5. The door engagement portion 31 includes the shaft-shaped engagement portion 41 as a guide engagement portion, and the vehicle body engagement portion 32 includes the guide groove 42 having a pair of side wall portions 42a and 42b facing each other and extending in the opening and closing operation direction of the door 5. In the vicinity of the fully closed position P0 of the door 5 where the door engagement portion 31 and the vehicle body engagement portion 32 are engaged with each other, the opening and closing operation of the door 5 is guided in a state where the shaft-shaped engagement portion 41 of the door engagement portion 31 is disposed in the guide groove 42 of the vehicle body engagement portion 32.

That is, the vehicle door device includes a door engagement portion provided at a close side end of the door that opens and closes a door opening of the vehicle based on an operation of the link mechanism, and a vehicle body engagement portion provided at a close side end of the door opening which the close side end of the door comes into contact with and is away from based on an opening and closing operation of the door, wherein one of the door engagement portion and the vehicle body engagement portion includes a guide engagement portion, and the other of the door engagement portion and the vehicle body engagement portion includes a guide groove having a pair of side wall portions facing each other and extending in an opening and closing operation direction of the door, and wherein in the vicinity of a fully closed position of the door where the door engagement portion and the vehicle body engagement portion are engaged with each other, an opening and closing operation of the door is guided in a state where the guide engagement portion is disposed in the guide groove.

According to the above configuration, the door 5 can be stably supported even in the vicinity of the fully closed position P0 where the distance between the first and second link arms 11 and 12 is short and the first and second link arms are likely to be linearly disposed. Further, when the door 5 is fully closed, a stable rotation fulcrum X5 of the door 5 is formed at the peripheral edge portion 83 of the door opening 3 with the door engagement portion 31 engaged with the vehicle body engagement portion 32 as the fulcrum forming portion 90. Thus, the swing of the door 5 can be suppressed, and the driving force of the opening and closing operation can be efficiently transmitted to the door 5. As a result, the door 5 of the vehicle 1 can be more suitably opened and closed.

(5) The first link arm 11 has the second rotation connection point X2 connected to the door 5 at a position closer to the center of gravity G of the door 5 than the second link arm 12.

According to the above configuration, the door 5 can be stably supported by the first link arm 11 served as the main link 21 that supports a larger load. By applying the driving torque to the main link 21, the swing of the door 5 caused by the application of the driving torque can be suppressed, and the door 5 can be stably opened and closed.

(6) The connection length variable mechanism 50 includes a joint link mechanism 60 formed by rotatably connecting the vehicle body link 51 having the first rotation connection point X1 with the door link 52 having the second rotation connection point X2.

That is, such a joint link mechanism 60 has a feature that it is hardly affected by a use environment such as foreign matters such as dust and dirt, or freezing. Thus, this can secure high reliability and durability. In addition, there is an advantage that the vehicle body link 51 and the door link 52 have a high degree of freedom in shape.

The above embodiment can be modified as follows. The above embodiment and the following modification examples can be implemented in combination with each other within a range not technically contradictory.
In the above embodiment, the driving torque is applied to and rotates the second rotation connection point X2 with respect to the door 5 with the first link arm 11 having the configuration as the main link 21 as the drive link 80. However, the present disclosure is not limited thereto, and the second link arm 12 having the configuration as the sub-link 22 may be set as the drive link 80. Both the first and second link arms 11 and 12 may be set as the drive link 80.
In the above embodiment, the door 5 is provided with the drive device 71. However, the present disclosure is not limited thereto, and the drive link 80 may be provided with the drive device 71, so that the drive device 71 rotates integrally with the drive link 80. Each of the door 5 and the drive link 80 may be provided with the drive device 71 that applies a driving torque to the second rotation connection point X2 with respect to the door 5.
In the above embodiment, the door engagement portion 31 has the shaft-shaped engagement portion 41 as the guide engagement portion, and the vehicle body engagement portion 32 has the guide groove 42. However, the present disclosure is not limited thereto, and the door engagement portion 31 may have the guide groove 42, and the vehicle body engagement portion 32 may have the shaft-shaped engagement portion 41.
Further, the shaft-shaped engagement portion 41 has a configuration as the roller 41x rotatably supported around the support shaft, but the shaft-shaped engagement portion 41 may not rotate. Furthermore, the guide engagement portion does not necessarily have a shaft shape. The guide groove 42 may also be changed in any shape. That is, in the vicinity of the fully closed position P0 where the door engagement portion 31 is engaged with the vehicle body engagement portion 32, the opening and closing operation of the door 5 may be guided in a state where the guide engagement portion is disposed in the guide groove 42.
In the embodiment described above, when the door is fully closed, the door engagement portion 31 engaged with the vehicle body engagement portion 32 functions as the fulcrum forming portion 90 that forms the rotation fulcrum X5 of the door 5 at the peripheral edge portion 83 of the door opening 3. However, the present disclosure is not limited thereto, and for example, the fulcrum forming portion 90 may be formed any manner so that, for example, part of the weather strip 87 provided at the peripheral edge portion 85 of the door 5 contacts the peripheral edge portion 83 of the door opening 3 to form the rotation fulcrum X5 of the door 5. Such a fulcrum forming portion 90 may not be provided. That is, the present disclosure may be applied to a configuration in which the door 5 is fully closed without turning around the rotation fulcrum X5.
In the above embodiment, the first link arm 11 having the configuration as the main link 21 is disposed above the second link arm 12 having the configuration as the sub-link 22. Then, the second link arm 12 is disposed at a position closer to the close side end 33 of the door 5 than the first link arm 11. However, the present disclosure is not limited thereto, and the arrangement of the first and second link arms 11 and 12 may be changed in any manner. For example, the second link arm 12 may have the second rotation connection point X2 at a position closer to the center of gravity G of the door 5 than the first link arm 11. In such a case, the second link arm 12 may be set as the drive link 80.
In the above embodiment, the connection length variable mechanism 50 is provided in the second link arm 12. However, the present disclosure is not limited thereto, and may be applied to a configuration in which the connection length variable mechanism 50 is provided in the first link arm 11. The present disclosure may be applied to a configuration in which the connection length variable mechanism 50 is provided in both the first and second link arms 11 and 12.
In addition, from the viewpoint of suppressing the swing of the door 5 due to the operation of the connection length variable mechanism 50 at the time of opening/closing drive of the door 5 by the drive device 71, it is desirable that the drive link 80 does not include the connection length variable mechanism 50. However, the present disclosure may have the configuration in which the drive link 80 includes the connection length variable mechanism 50.
In the embodiment described above, the connection length variable mechanism 50 has a configuration as the joint link mechanism 60 formed by rotatably connecting the vehicle body link 51 having the first rotation connection point X1 and the door link 52 having the second rotation connection point X2. However, the present disclosure is not limited to this, and the connection length variable mechanism 50 may be changed to have any configuration such as using a direct-acting expansion/contraction link mechanism or the like. Such a connection length variable mechanism 50 may be applied to a configuration in which neither the first link arm 11 nor the second link arm 12 is provided.
In the above embodiment, the present disclosure is applied to the configuration in which the door 5 of the vehicle 1 performs the opening operation toward the vehicle rear side, but the present disclosure may be applied to the configuration in which the door 5 performs the opening operation toward the vehicle front side.

Next, a technical idea that can be grasped from the above embodiment and modification will be described.

(a) A vehicle door device having a feature that of the first and second link arms, one having the second rotation connection point at a position closer to the center of gravity of the door is set as the drive link.

According to the above configuration, it is possible to stably open and close the door while suppressing the swing of the door caused by the application of the driving torque. Thus, the door of the vehicle can be more suitably opened and closed.

(b) A vehicle door device having a feature that the connection length variable mechanism is a joint link mechanism formed by rotatably connecting the vehicle body link having the first rotation connection point with the door link having the second rotation connection point.

That is, such a joint link mechanism has a feature that it is hardly affected by a use environment such as foreign matters such as dust and dirt, or freezing. Thus, this can secure high reliability and durability. In addition, there is an advantage that the vehicle body link and the door link have a high degree of freedom in shape.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle door device comprising:
first and second link arms each of which has a first rotation connection point with respect to a vehicle body and a second rotation connection point with respect to a door of a vehicle; and
a drive device that opens and closes the door based on an operation of a link mechanism formed by the first and second link arms by rotating at least one of the first and second link arms as a drive link, wherein
the drive device rotates the drive link by applying a driving torque to the second rotation connection point.

2. The vehicle door device according to claim 1, wherein
the door includes a fulcrum forming portion that forms a rotation fulcrum of the door at a peripheral edge portion of a door opening where the door is provided when the door is fully closed, and performs the fully closing operation, and wherein
one, of the first and second link arms, having the second rotation connection point at a position farther from the fulcrum forming portion is set as the drive link.

3. The vehicle door device according to claim 1, further comprising:
a connection length variable mechanism provided at one of the first and second link arms and allowed to change a connection length between the first and second rotation connection points, wherein
an opening and closing operation locus of the door changes based on an operation of the connection length variable mechanism, and wherein
the other, of the first and second link arms, not provided with the connection length variable mechanism is set as the drive link.

4. The vehicle door device according to claim 2, further comprising:
a connection length variable mechanism provided at one of the first and second link arms and allowed to change a connection length between the first and second rotation connection points, wherein
an opening and closing operation locus of the door changes based on an operation of the connection length variable mechanism, and wherein
the other, of the first and second link arms, not provided with the connection length variable mechanism is set as the drive link.

5. The vehicle door device according to claim 1, further comprising:
a door engagement portion provided at a close side end of the door that opens and closes a door opening of the vehicle based on an operation of the link mechanism; and
a vehicle body engagement portion provided at a close side end of the door opening which the close side end of the door comes into contact with and is away from based on an opening and closing operation of the door, wherein
one of the door engagement portion and the vehicle body engagement portion includes a guide engagement portion, and
the other of the door engagement portion and the vehicle body engagement portion includes a guide groove having a pair of side wall portions facing each other and extending in an opening and closing operation direction of the door, and wherein
in the vicinity of a fully closed position of the door where the door engagement portion and the vehicle body engagement portion are engaged with each other, an opening and closing operation of the door is guided in a state where the guide engagement portion is disposed in the guide groove.

6. The vehicle door device according to claim 2, further comprising:
a door engagement portion provided at a close side end of the door that opens and closes a door opening of the vehicle based on an operation of the link mechanism; and
a vehicle body engagement portion provided at a close side end of the door opening which the close side end of the door comes into contact with and is away from based on an opening and closing operation of the door, wherein
one of the door engagement portion and the vehicle body engagement portion includes a guide engagement portion, and
the other of the door engagement portion and the vehicle body engagement portion includes a guide groove having a pair of side wall portions facing each other and extending in an opening and closing operation direction of the door, and wherein
in the vicinity of a fully closed position of the door where the door engagement portion and the vehicle body engagement portion are engaged with each other, an opening and closing operation of the door is guided in a state where the guide engagement portion is disposed in the guide groove.

7. The vehicle door device according to claim 3, further comprising:
a door engagement portion provided at a close side end of the door that opens and closes a door opening of the vehicle based on an operation of the link mechanism; and
a vehicle body engagement portion provided at a close side end of the door opening which the close side end of the door comes into contact with and is away from based on an opening and closing operation of the door, wherein
one of the door engagement portion and the vehicle body engagement portion includes a guide engagement portion, and
the other of the door engagement portion and the vehicle body engagement portion includes a guide groove having a pair of side wall portions facing each other and extending in an opening and closing operation direction of the door, and wherein
in the vicinity of a fully closed position of the door where the door engagement portion and the vehicle body engagement portion are engaged with each other, an opening and closing operation of the door is guided in a state where the guide engagement portion is disposed in the guide groove.

8. The vehicle door device according to claim 4, further comprising:
a door engagement portion provided at a close side end of the door that opens and closes a door opening of the vehicle based on an operation of the link mechanism; and
a vehicle body engagement portion provided at a close side end of the door opening which the close side end of the door comes into contact with and is away from based on an opening and closing operation of the door, wherein
one of the door engagement portion and the vehicle body engagement portion includes a guide engagement portion, and
the other of the door engagement portion and the vehicle body engagement portion includes a guide groove having a pair of side wall portions facing each other and extending in an opening and closing operation direction of the door, and wherein
in the vicinity of a fully closed position of the door where the door engagement portion and the vehicle body engagement portion are engaged with each other, an opening and closing operation of the door is guided in a state where the guide engagement portion is disposed in the guide groove.
